(19) United States
(12) Patent Application Publication
(10) Pub. No.: US 2009/0262015 A1
(43) Pub. Date: Oct. 22, 2009

(54) MOBILE COMMUNICATION DEVICE POSITIONING SYSTEM AND METHOD FOR ENHANCING POSITION MEASUREMENT BY SELF LEARNING ALGORITHM

(76) Inventors: Tae Il Kim, Seoul (KR); Tae Joon Ha, Kyunggi-do (KR); Hyuk Jin Sohn, Seoul (KR); Hyun Ok Park, Seoul (KR); Won Seok Lee, Seoul (KR)

Correspondence Address: NIXON & VANDERHYE, PC, 901 NORTH GLEBE ROAD, 11TH FLOOR, ARLINGTON, VA, 22203, US

(21) Appl. No.: 12/089,661

(22) PCT Filed: Sep. 15, 2006
(86) PCT No.: PCT/KR06/03682

§ 371 Date: Sep. 8, 2008

(30) Foreign Application Priority Data
Oct. 13, 2005 (KR) 10-2005-0096385

(51) Int. Cl. G01S 1/00

(52) U.S. Cl. 342/357.09

(57) ABSTRACT

A method and system for determining a location of a mobile communication device for an improvement of a positioning through a self-learning processing algorithm. In the method and system for determining a location of a mobile communication device, a self-learning processing unit batch processes GPS-based positioning results accumulated in a first self-learning database, and generates a sector direction value. Also, the self-learning processing unit generates optimized environment parameters, which is necessary for wireless network-based positioning, and basic data for a pattern matching, and updates the optimized environment parameters and basic data in a second self-learning database. Accordingly, the system for determining a location of a mobile communication device performs a positioning through a pattern matching method by using results accumulated in the second self-learning database.

### TECHNICAL FIELD

The present invention relates to a system for and a method of determining a location of a mobile communication device, and more particularly, to a system for and a method of determining a location of a mobile communication device to improve a wireless network-based positioning technology by integrating a Global Positioning System (GPS)-based positioning technology with a self-learning processing algorithm.

### BACKGROUND ART

Various types of services, based on a location of a mobile communication device, are currently being developed. Specifically, when a user has the mobile communication device, the user may easily and conveniently acquire information associated with a current location of the mobile communication device. For example, services, such as traffic information informing about traffic status, neighboring area information, tour information, and the like, may be provided to the user. Also, a physical distribution management service (e.g., a freight and vehicle tracing service), or a mobile commerce for local products, souvenir shopping, ticket purchasing, and the like, may be based on the location of the mobile communication device.

FIG. 1 is a diagram illustrating a general Global Positioning System (GPS)-based positioning technology. Referring to FIG. 1, in a general GPS system 100, a mobile communication device 120 which is installed with a GPS receiver receives a signal from a plurality of GPS satellites 110. In this instance, the GPS receiver is not shown in FIG. 1, and the signal is associated with navigation. Accordingly, the mobile communication device 120 may determine a current location. The GPS receiver calculates location information such as longitudinal and latitudinal coordinates by using a GPS-based positioning system. According to such location information, a positioning server associated with a base station provides a user location-based service.

FIG. 2 is a diagram illustrating a general wireless network-based positioning technology. Referring to FIG. 2, a mobile communication device in a mobile communication network communicates with a plurality of base stations, for example, BS1, BS2, and BS3, while transceiving unique identification information. In the general wireless network-based positioning technology installed in the mobile communication device, a location X (x, y, z) of the mobile communication device is determined by using a base station identification signal from each of the plurality of base stations BS1, BS2, and BS3. Examples of the wireless network-based positioning technology include Trueposition's Uplink-time difference of arrival (U-TDOA) technology, Qualcomm/SnapTrack Corporation's Advanced forward link trilateration (AFLT) technology (gpsOne), and the like, which use a time difference or a phase difference of a signal received from the plurality of base stations.

Also, as a disadvantage of the wireless network-based positioning technology, for example, a difficulty of positioning with respect to a tunnel or a basement which does not easily admit a signal from a satellite, exists. In order to overcome the disadvantage, Qualcomm/SnapTrack Corporation's assisted-global positioning system (A-GPS) technology, American Surf Corporation's A-GPS technology, British Cambridge Positioning System (CPS) Corporation's Enhanced Observed Time Difference (E-OTD) technology, and the like are used. In such technologies, the wireless network-based positioning technology is used in the GPS-based positioning technology.

Also, a database pattern matching technology determines a current location of a mobile communication device by creating a database with respect to signal values, which are received from a plurality of base stations, for each location, and comparing the signal values with a measured signal value. However, in the case of the database pattern matching technology, it is required to make a database with respect to signal values in a great number of locations. Also, every time a location of a base station, a direction, a location of neighboring buildings, and the like, are changed, the database must be updated to reflect the change. Thus, a great amount of costs may be spent for constructing, maintaining, and managing the database.

Researches to overcome an excessive positioning error or a positioning failure in an indoor or shadow region are still being conducted in the wireless network-based positioning technology. Such hardware approaches as described above require a huge cost and a system change so as to improve a performance of the wireless network-based positioning technology. Accordingly, domestic and foreign mobile carriers may not adopt the technology to for a commercialized product. Also, a technology to determine a location of the mobile communication device, based on software, has been tried. However, the technology's only approach is using a simple mathematical algorithm. Also, the technology is an inaccurate method since many characteristics of a mobile communication network are not considered, and thus the technology may not be commercialized. Moreover, the technology may not enhance a performance of a positioning technology according to a worldwide mobile communication network environment. Accordingly, a method which may cope with a continuously changing network environment by integrating the GPS-based positioning technology with the wireless network-based positioning technology is provided.

### DISCLOSURE OF INVENTION

### Technical Goals

The present invention provides a system for and a method of determining a location of a mobile communication device which self-corrects base station information and an environmental variable of a mobile communication network by using an accuracy of a GPS-based positioning result, for an improvement of a wireless network-based positioning system without an additional cost.

The present invention also provides a system for and a method of determining a location of a mobile communication device which may overcome an excessive positioning error or a positioning failure through a self-learning processing algorithm even when signals received from a plurality of base stations in a mobile communication network are unstable.

### Technical Solutions

According to an aspect of the present invention, there is provided a system for determining a location of a mobile communication device using a satellite signal, the system including: a first self-learning database storing a GPS-based positioning result, wireless network information for a base station identification, and a wireless network-based positioning result; a self-learning processing unit performing self-learning and generating a self-learning processing result associated with the network-based positioning by using the GPS-based positioning result, the wireless network information for the base station identification, and the wireless network-based positioning result; a second self-learning database accumulating the self-learning processing result corresponding to base station information; and a wireless network-based positioning unit generating the wireless network-based positioning result via the network-based positioning using the self-learning processing result, and updating the generated wireless network-based positioning result in the first self-learning database, wherein the self-learning processing unit performs the self-learning by reapplying the wireless network-based positioning according to a predetermined standard and updating the self-learning processing result.

According to another aspect of the present invention, there is provided a method of determining a location of a mobile communication device using a satellite signal, the method including: storing a GPS-based positioning result, wireless network information for a base station identification, and a wireless network-based positioning result; performing self-learning and generating a self-learning processing result associated with the network-based positioning by using the GPS-based positioning result, the wireless network information for the base station identification, and the wireless network-based positioning result; accumulating the self-learning processing result corresponding to base station information; and generating the wireless network-based positioning result via the wireless network-based positioning using the self-learning processing result, and updating the generated wireless network-based positioning result in the first self-learning database, wherein the self-learning reapplies the wireless network-based positioning according to a predetermined standard and updates the self-learning processing result.

### BRIEF DESCRIPTION OF DRAWINGS

FIG. 1 is a diagram illustrating a general Global Positioning System (GPS)-based positioning technology;

FIG. 2 is a diagram illustrating a general wireless network-based positioning technology;

FIG. 3 is a block diagram illustrating a system which determines a location of a mobile communication device in real time according to an embodiment of the present invention;

FIG. 4 is a diagram illustrating a batch method in the system of FIG. 3;

FIG. 5 is a flowchart illustrating an operation of a system for determining a location of a mobile communication device according to an embodiment of the present invention;

FIG. 6 is a diagram illustrating a data configuration which is used for predicting a direction of a base station sector according to an embodiment of the present invention;

FIG. 7 is a conceptual diagram illustrating an example of a direction of a base station sector which is predicted by using of GPS-based positioning results according to an embodiment of the present invention;

FIG. 8 is a diagram illustrating a sector direction prediction and an improved wireless network-based positioning result when a single sector identifier is received;

FIG. 9 is a diagram illustrating a sector direction prediction and an improved wireless network-based positioning result when two sector identifiers of a single base station are received;

FIG. 10 is a diagram illustrating a sector direction prediction and an improved wireless network-based positioning result when two sector identifiers of two base stations are received respectively;

FIG. 11 is a diagram illustrating an improved wireless network-based positioning result of a mobile communication device located outside of a base station;

FIG. 12 is a diagram illustrating a data configuration with respect to a GPS-based positioning result and a wireless network-based positioning result which will be used in a self-learning processing algorithm according to an embodiment of the present invention; and

FIG. 13 is a diagram illustrating an example of a data configuration with respect to GPS-based positioning results which is used as a basic data of pattern matching technology as a wireless network-based positioning technology according to an embodiment of the present invention.

### BEST MODE FOR CARRYING OUT THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

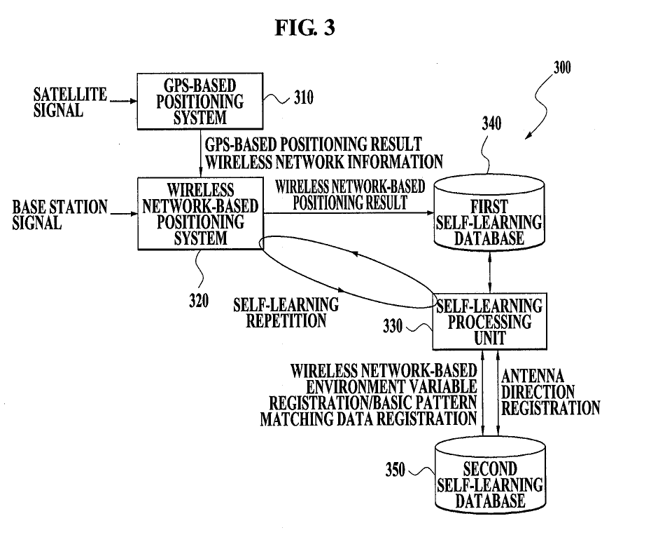

FIG. 3 is a block diagram illustrating a system which determines a location of a mobile communication device in real time according to an embodiment of the present invention. Referring to FIG. 3, the system for determining a location of a mobile communication device 300 includes a Global Positioning System (GPS)-based positioning system 310, a wireless network-based positioning system 320, a self-learning processing unit 330, a first self-learning database (SLDB) 340, and a second SLDB 350.

The system for determining a location of a mobile communication device 300 is provided to improve a performance of a wireless network-based positioning by using a positioning result of the GPS-based positioning system 310. The system for determining a location of a mobile communication device 300 is installed in a portable device such as a mobile communication device, and accurately calculates current location information of the portable device with respect to a particular request. Accordingly, the system for determining a location of a mobile communication device 300 may be used to receive location-based services, such as traffic information informing about traffic status, neighboring area information, tour information, and the like.

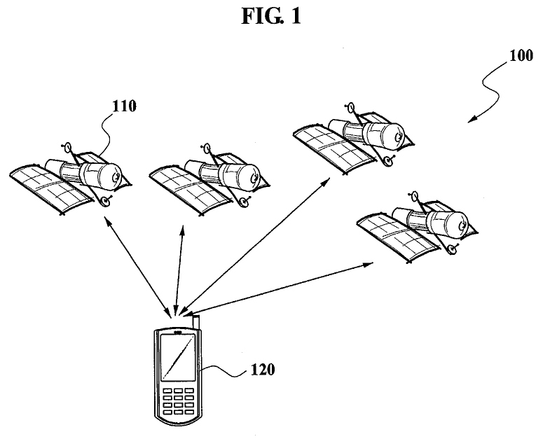

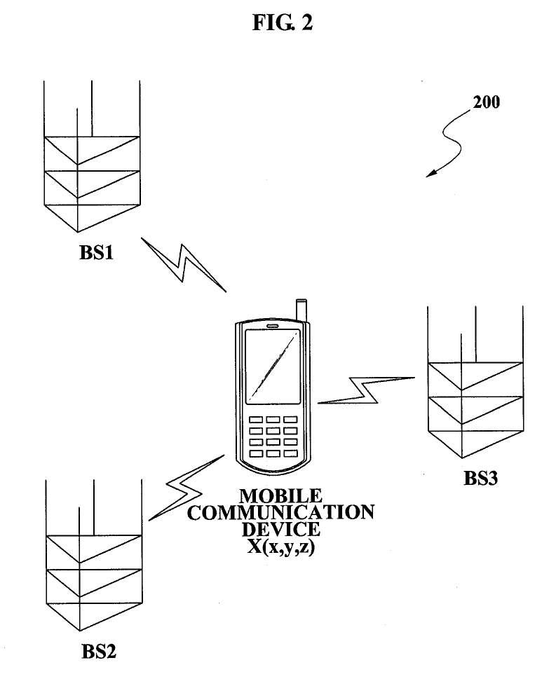

The GPS-based positioning system 310 corresponds to a unit which performs a positioning for calculating the current location information of the portable device, such as longitudinal and latitudinal coordinates. In this instance, the GPS-based positioning system 310 is installed with a predetermined GPS receiver, and receives a signal associated with a navigation from satellites, as illustrated in FIG. 1. Also, the GPS-based positioning system 310 uses wireless network information according to a GPS-based positioning algorithm. The wireless network-based positioning system 320 corresponds to a unit which performs the wireless network-based positioning. In this instance, the wireless network-based positioning system 320 receives a base station identification signal from base stations, as illustrated in FIG. 2. The wireless network information corresponds to base station location information in a wireless network, and information for identifying a base station. The information for identifying the base station is used in positioning, and includes a base station identifier or a base station-related sector (antenna) identifier.

The first SLDB 340 accumulates GPS-based positioning results and the wireless network information which are received from the GPS-based positioning system 310. Also, the first SLDB 340 accumulates wireless network-based positioning results which are received from the wireless network-based positioning system 320.

Particularly, the self-learning processing unit 330 performs a self-learning processing algorithm by using the information accumulated in the first SLDB 340 in order to improve the wireless network-based positioning in the wireless network-based positioning system 320. Accordingly, self-learning processing results are accumulated in the second SLDB 350. In this instance, the self-learning processing results correspond to base station information generated in the self-learning processing unit 330. In self-learning of the self-learning processing unit 330 according to the self-learning processing algorithm, the base station information in the wireless network, environment variables, and the like are self-corrected using an accuracy of the GPS-based positioning results accumulated in the first SLDB 340. Accordingly, when the wireless network-based positioning system 320 performs the wireless network-based positioning, the system for determining a location of a mobile communication device 300 may overcome an excessive positioning error or a positioning failure even when signals received from the base stations in a mobile communication network are unstable. Thus, the wireless network-based positioning may be improved.

The wireless network-based positioning system 320 links with the self-learning processing unit 330 and performs the wireless network-based positioning using the self-learning processing results from the second SLDB 350. Also, the wireless network-based positioning system 320 stores the generated wireless network-based positioning results in the first SLDB 340.

The GPS-based positioning results, the wireless network information, and the wireless network-based positioning results may be stored in the first SLDB 340 in real time or by a batch method when performing the positioning. In this instance, the wireless network information and the wireless network-based positioning results are used in the GPS-based positioning.

As an example, in a real time method as illustrated in FIG. 3, the wireless network-based positioning system 320 may store the GPS-based positioning results, the wireless network information, and the wireless network-based positioning results in the first SLDB 340 in real time, when the GPS-based positioning system 310 receives a request for the location-based services from a user and performs the positioning.

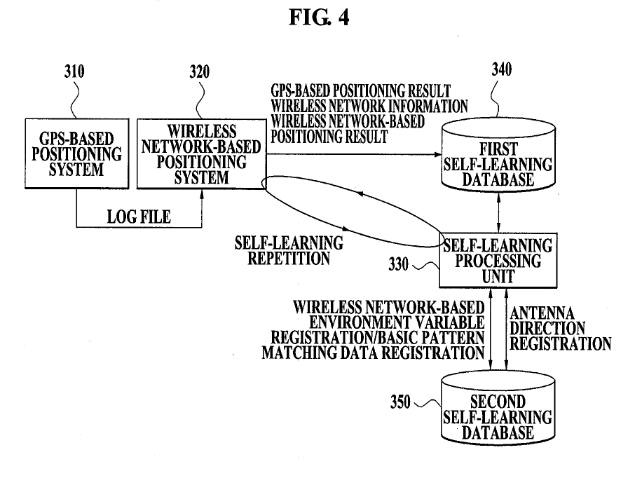

FIG. 4 is a diagram illustrating a batch method in the system of FIG. 3.

In the batch method, the wireless network-based positioning system 320 may store the wireless network-based positioning results, GPS-based positioning result, and the wireless network information in the first SLDB 340. In this instance, the GPS-based positioning result and the wireless network information are stored as a log file by the GPS-based positioning unit 310. The GPS-based positioning system 310 may update the GPS-based positioning results and the wireless network information with a log file every time the GPS-based positioning system 310 performs the positioning. In this instance, a recent positioning result is based on the GPS-based positioning results and the wireless network information. The log file may be periodically reset after being stored in the first SLDB 340.

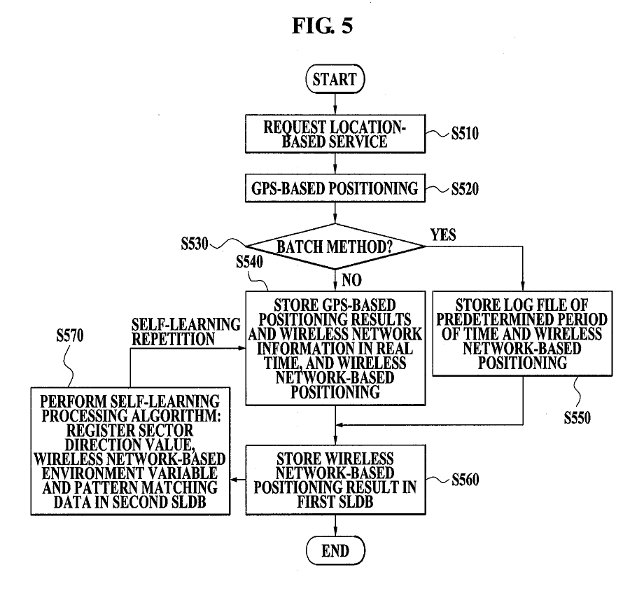

Hereinafter, an operation of the system for determining a location of a mobile communication device 300 according to an embodiment of the present invention is described in detail with reference to FIG. 5.

FIG. 5 is a flowchart illustrating an operation of a system for determining a location of a mobile communication device according to an embodiment of the present invention.

In operation S510, a user requests a location-based service via a user interface, through a mobile communication device 300 installed with the system for determining a location of a mobile communication device 300. In operation S520, the GPS-based positioning system 310 performs a positioning to calculate current location information of the mobile communication device 300 such as longitudinal and latitudinal coordinates by using wireless network information according to a GPS-based positioning algorithm. In a general GPS-based positioning algorithm, a navigational signal received from three satellites according to a triangulation method is used. Also, a signal from an observatory satellite to correct a time error may be used. Twenty four GPS satellites orbit the Earth at an altitude of about 20,000 km, and are used to precisely determine a current location anywhere in the world. The GPS-based positioning system 310 may use a signal strength as well as base station location information, and wireless network information such as a base station identifier or a base station-related sector identifier, e.g. an antenna. In this instance, the signal strength is of the signal received from the satellites, and the base station location information is for identifying a base station.

In operation S530, the GPS-based positioning results and the wireless network information are stored in the first SLDB 340 in real time or by a batch method. In this instance, the GPS-based positioning results are generated by the GPS-based positioning system 310, and the wireless network information is used in the GPS-based positioning.

In operation S540, the wireless network-based positioning system 320 stores the GPS-based positioning results and the wireless network information in the first SLDB 340, when the GPS-based positioning system 310 generates the GPS-based positioning results. In this instance, the wireless network-based positioning system 320 applies the self-learning processing results from the second SLDB 350, to base station identification signals received from the base stations, and thereby performs a wireless network-based positioning. The wireless network-based positioning system 320 receives and uses the self-learning processing results via the self-learning processing unit 330. In this instance, the self-learning processing results are accumulated in the second SLDB 350, and the self-learning processing unit 330 is linked with the wireless network-based positioning system 320. In operation S560, the wireless network-based positioning result which is generated by the wireless network-based positioning system 320 may be stored in the first SLDB 340.

A mobile communication device which is moving may communicate with the base stations in a mobile communication network, while transceiving unique identification information and data such as short message data or voice data. Even when the mobile communication device is in a standby mode, in which the mobile communication device does not send a message or connect to an Internet, the base stations may transmit and receive the base station identification signals with the mobile communication device, and check a current status of the mobile communication device.

In the batch method, in operation S550, the wireless network-based positioning system 320 may store the GPS-based positioning result and the wireless network information in the first SLDB 340. In this instance, the GPS-based positioning result and the wireless network information are stored as a log file by the GPS-based positioning unit 310. Also, in operation S560, the wireless network-based positioning result which is generated by the wireless network-based positioning system 320 may be stored in the first SLDB 340.

The wireless network-based positioning result may return to the mobile communication device of the user that requested the location-based service. Accordingly, a linked predetermined server may provide various services based on the current location of the mobile communication device.

In operation S570, when the GPS-based positioning system 310 or the wireless network-based positioning system 320 performs a positioning, the self-learning processing unit 330 updates the self-learning processing results which are accumulated in the second SLDB 350, by using a result of the positioning. The updating is for improving a positioning accuracy of the wireless network-based positioning system 320. According to the updated self-learning processing results in the second SLDB 350, the wireless network-based positioning system 320 performs the wireless network-based positioning with respect to a subsequent service request in operation S540.

The self-learning processing results correspond to base station information and are stored. Also, the self-learning processing results include a sector direction value. In this instance, the sector direction value is generated by using the GPS-based positioning results which are accumulated in the first SLDB 340. The self-learning processing results include optimized environment parameters to be used in the wireless network-based positioning. In this instance, the sector direction value may be a portion of the optimized environment parameters.

The self-learning processing unit 330 searches the first SLDB 340 according to the base station identifier or a sector identifier of the base station information of the second SLDB 350, and extracts GPS-based positioning results. In this instance, the base station identifier or the sector identifier of the base station information corresponds to a base station identification signal which is currently received in the wireless network-based positioning system 320. In order to improve a reliability, the self-learning processing unit 330 first uses corresponding GPS-based positioning results which have a high signal strength of the wireless network information and a high accuracy of the positioning, from the extracted GPS-based positioning results.

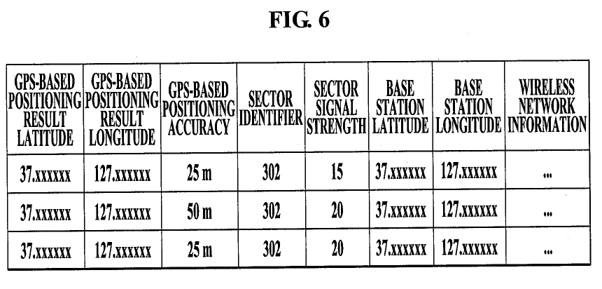

FIG. 6 is a diagram illustrating a data configuration which is used for predicting a direction of a base station sector according to an embodiment of the present invention. As illustrated in FIG. 6, wireless network information and GPS-based positioning result, which are necessary for positioning, are stored in the first SLDB 340. In this instance, the GPS-based positioning result includes a GPS-based positioning result latitude, a GPS-based positioning result longitude, and a GPS-based positioning accuracy. Also, the wireless network information includes a base station identifier or a sector identifier, a sector signal strength, a base station latitude, and a base station longitude. Also, the first SLDB 340 corresponds to data which is stored as illustrated in FIG. 6, and stores a wireless network-based positioning result. The self-learning processing unit 330 extracts data which will be first used from GPS-based positioning results as illustrated in FIG. 6. In this instance, the GPS-based positioning results are extracted from the first SLDB 340. Specifically, the self-learning processing unit 330 first uses corresponding GPS-based positioning results, and performs a self-learning processing algorithm. In this instance, in the corresponding GPS-based positioning results, a strength or a positioning accuracy of a received signal of the wireless network information is determined to be high enough to improve the reliability.

As illustrated in FIG. 6, when the GPS-based positioning results to be first used in the self-learning processing algorithm are distributed at a predetermined latitude and longitude from a base station, the self-learning processing unit 330 matches an average distribution direction to a sector direction, and updates a corresponding sector direction value in the second SLDB 350.

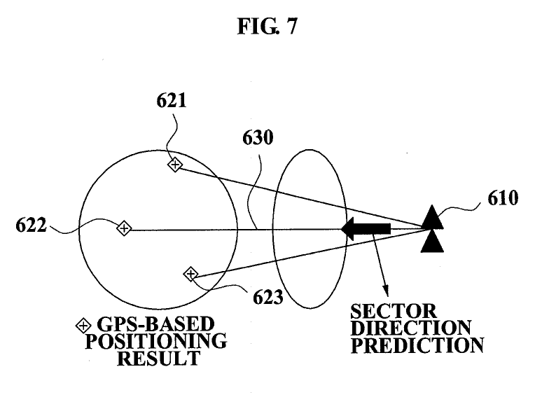

FIG. 7 is a conceptual diagram illustrating an example of-omit a direction of a base station sector which is predicted by using GPS-based positioning results according to an embodiment of the present invention.

As illustrated in FIG. 7, as an example, the self-learning processing unit 330 may update an open angle among the GPS-based positioning results 621, 622, and 623, or a sector direction value as an optimized environment parameter in the second SLDB 350. In this instance, the open angle refers to an angle where the GPS-based positioning results 621, 622, and 623, of corresponding base station identification signals, are distributed from a base station 610. Also, the sector direction value corresponds to an average distribution direction 630 of the open angle.

An accuracy of a wireless network-based positioning may be improved by using the open angle or the sector direction value described above. As an example, it is simple to determine that a mobile communication device is located within the sector direction value or the open angle with respect to a base station identification signal which is received by the mobile communication device.

Also, to improve the accuracy of the wireless network-based positioning even more, the self-learning processing unit 330 may update a parameter set having an optimal network-based positioning result from prepared parameter sets in the second SLDB 350, and manage and maintain the parameter set. The prepared parameter sets are parameters for updating the second SLDB 350 via self-learning. Also, the prepared parameter sets may include a corresponding base station identifier or sector identifier, and the corresponding open angle or sector direction value. Also, the prepared parameter sets may include sector identifiers associated with the corresponding base station identifier or sector identifier.

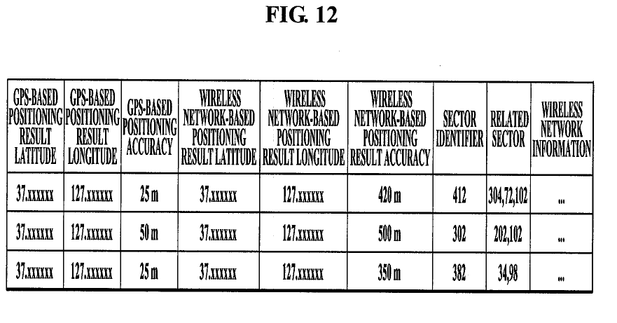

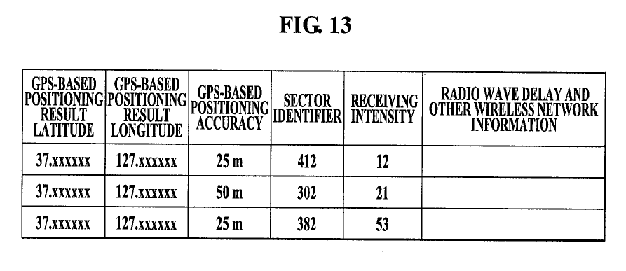

The self-learning processing unit 330 periodically locates the first SLDB 340 in a batch method. Also, the self-learning processing unit 330 extracts network-based positioning results having a difference between the GPS-based positioning result and the wireless network-based positioning result, from the first self-learning database, as illustrated in FIG. 12. In this instance, the difference is greater than a predetermined value. As illustrated in FIG. 12, sectors which are associated with a corresponding base station signal may be stored in the first SLDB 340. The self-learning processing unit 330 reapplies a wireless network-based positioning with respect to the extracted wireless network-based positioning result according to the prepared parameter sets, by the wireless network-based positioning system 320. The self-learning processing unit 330 bases an optimal positioning result of the extracted wireless network-based positioning result on the self-learning processing result, and thereby updates the optimal positioning result in the second SLDB 350. In this instance, the optimal positioning result corresponds to a least value of the difference between the wireless network-based positioning result and a corresponding parameter set. Specifically, the self-learning processing unit 330 recalculates an environment parameter such as the sectors or the sector direction value with respect to the wireless network-based positioning result having the difference greater than the predetermined value. Also, the self-learning processing unit 330 updates the environment parameter with data which is similar to a configuration of FIG. 12 in the second SLDB 350. The second SLDB 350 base the environment parameter on the self-learning processing result, and stores the environment parameter. In this instance, the environment parameter includes the corresponding base station identifier or sector identifier, the open angle or the sector direction value, and the sectors. Also, the second SLDB 350 may include all data which is similar to data of the first SLDB 340 as illustrated in FIGS. 6 and 12. The second SLDB 350 may base pattern matching data, as illustrated in FIG. 13, on the self-learning processing result, and store the pattern matching data. The pattern matching data is for positioning by a pattern matching.

In the self-learning processing algorithm, when the optimal network-based positioning result with respect to the prepared parameter sets is greater than the predetermined value, the self-learning processing unit 330 displays a diagnose flag with respect to a region corresponding to the extracted wireless network-based positioning result. Also, the self-learning processing unit 330 registers the diagnose flag in the second SLDB 350, and thus an operator of the system may initiate a self-diagnostics operation for a corresponding region.

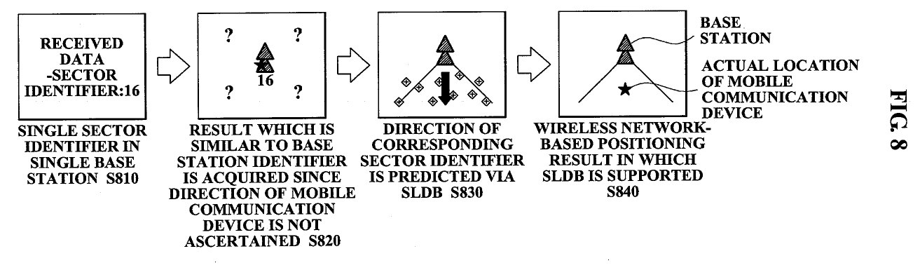

Hereinafter, referring to FIGS. 8, 9, 10, and 11, a method of determining a location according to the present invention and a method of determining a location according to a conventional art, depending on a number of sector identifier which is received from base stations in a mobile communication device, are compared.

FIG. 8 is a diagram illustrating a sector direction prediction and an improved wireless network-based positioning result when a single sector identifier is received. As an example, in operation S810, when a single sector identifier, for example, 16, belonging to a single base station is extracted by a positioning via the wireless network-based positioning system 320, a direction of a mobile communication device is not ascertained in a conventional art. In this instance, in the conventional art, the first SLDB 340 and the second SLDB 350 according to an embodiment of the present invention are not applied. Accordingly, in operation S820, a current location of the mobile communication device, which is illustrated as a star, is determined to be a rough result. The rough result is similar to a location of a corresponding base station including a sector identifier. Specifically, the mobile communication device may be determined to be located in the location of the corresponding base station, since a sector direction is not ascertained. However, in the wireless network-based positioning where the first SLDB 340 and the second SLDB 350 are applied, according to an embodiment of the present invention, a corresponding sector direction may be predicted according to a self-learning processing result stored in the second SLDB 350, in operation S830. Accordingly, the current location of the mobile communication device, which is illustrated as the star, is determined more precisely in operation S840. Specifically, the current location of the mobile communication device may be determined as an average distribution direction of GPS-based positioning results.

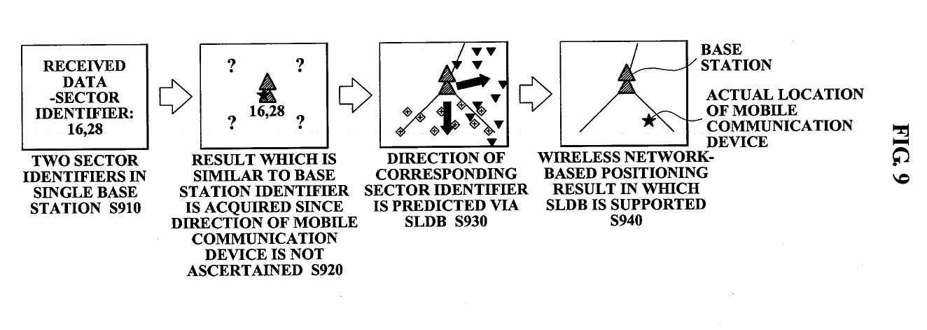

FIG. 9 is a diagram illustrating a sector direction prediction and an improved wireless network-based positioning result when two sector identifiers of a single base station are received.

As an example, in operation S910, when two sector identifiers, for example, 16 and 28, belonging to a single base station are extracted by a positioning via the wireless network-based positioning system 320, a direction of a mobile communication device is not ascertained in a conventional art. In this instance, in the conventional art, the first SLDB 340 and the second SLDB 350 according to an embodiment of the present invention are not applied. Accordingly, in operation S920, a current location of the mobile communication device, which is illustrated as a star, is determined to be a rough result. The rough result is similar to a location of a corresponding base station including a sector identifier. Specifically, the mobile communication device may be determined to be located in the location of the corresponding base station, since a sector direction is not ascertained. However, in the wireless network-based positioning where the first SLDB 340 and the second SLDB 350 are applied, according to an embodiment of the present invention, a corresponding sector direction may be predicted according to a self-learning processing result stored in the second SLDB 350, in operation S930. Accordingly, the current location of the mobile communication device, which is illustrated as the star, is determined more precisely in operation S940. Specifically, the current location of the mobile communication device may be determined as an average distribution direction of GPS-based positioning results.

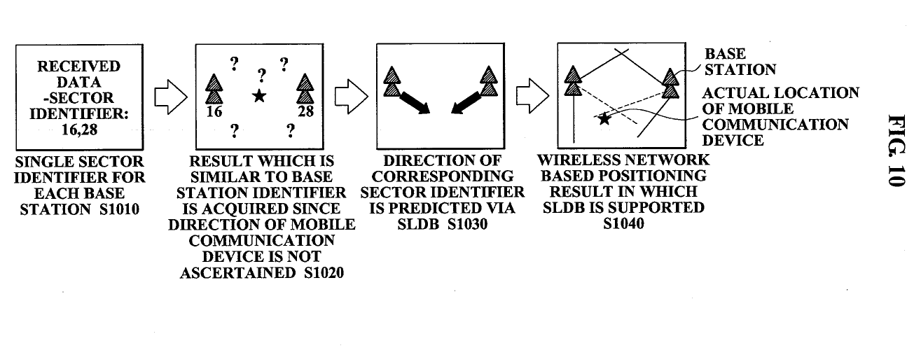

FIG. 10 is a diagram illustrating a sector direction prediction and an improved wireless network-based positioning result when two sector identifiers of two base stations are received respectively.

As an example, in operation S1010, when two sector identifiers, for example, 16 and 28, belonging to two base stations respectively, are extracted by a positioning via the wireless network-based positioning system 320, a direction of a mobile communication device is not ascertained in a conventional art. In this instance, in the conventional art, the first SLDB 340 and the second SLDB 350 according to an embodiment of the present invention are not applied. Accordingly, in operation S1020, a current location of the mobile communication device, which is illustrated as a star, is determined to be a rough result. The rough result is similar to a location among base stations. However, in the wireless network-based positioning where the first SLDB 340 and the second SLDB 350 are applied, according to an embodiment of the present invention, a corresponding sector direction may be predicted according to a self-learning processing result stored in the second SLDB 350, in operation S1030. Accordingly, the current location of the mobile communication device, which is illustrated as the star, may be determined more precisely in operation S1040. Specifically, the current location of the mobile communication device may be determined as an average distribution direction of GPS-based positioning results, which is associated with the two sectors identifiers from a location of the base station.

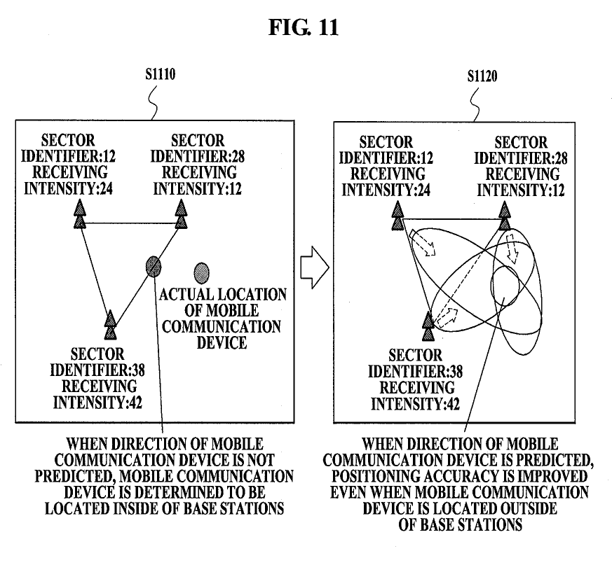

FIG. 11 is a diagram illustrating an improved wireless network-based positioning result of a mobile communication device located outside a range of a base station.

As an example, in operation S1110, when three sector identifiers, for example, 12, 28 and 38, belonging to three base stations respectively, are extracted by a positioning via the wireless network-based positioning system 320, a direction of a mobile communication device is not ascertained in a conventional art. In this instance, in the conventional art, the first SLDB 340 and the second SLDB 350 according to an embodiment of the present invention are not applied. Accordingly, in operation S1110, a current location of the mobile communication device is determined to be a particular location within a triangular region. In this instance, the triangular region is formed by the three base stations. However, in the wireless network-based positioning where the first SLDB 340 and the second SLDB 350 are applied, according to an embodiment of the present invention, a corresponding sector direction may be predicted. Accordingly, the current location of the mobile communication device may be determined more precisely in operation S1120, even when the mobile communication device is located outside a range of the base stations.

The wireless network-based positioning may be a positioning achieved by a pattern matching method. The pattern matching method uses data which is accumulated in the second SLDB 350. As an example, data which is accumulated in the first SLDB 340 may base the self-learning processing result of the second SLDB 350 on data to be used in the pattern matching method by the self-learning processing unit 330, and may be accumulated.

FIG. 13 is a diagram illustrating an example of a data configuration with respect to GPS-based positioning results which is used as basic data of pattern matching technology in a wireless network-based positioning technology according to an embodiment of the present invention.

For a positioning by a pattern matching method according to an embodiment of the present invention, as illustrated in FIG. 13, pattern matching data is accumulated as the self-learning processing result in the second SLDB 350. In this instance, the pattern matching data includes GPS-based positioning result and base station signal information. Also, the GPS-based positioning result includes a GPS-based positioning result latitude, a GPS-based positioning result longitude, and a GPS-based positioning accuracy. The base station signal information includes a sector identifier, a receiving intensity, a delay value of a base station identification signal for each location, and other wireless network information. Accordingly, the wireless network-based positioning system 320 searches for corresponding location information with respect to a currently received base station identification signal in the pattern matching data, and thereby may generate the corresponding location information as corresponding wireless network-based positioning result. The wireless network-based positioning result may be updated and accumulated in the first SLDB 340 in a same method as a method described above.

Basically, an enormous database having a base station identification signal for each location is required to be previously established so as to apply a positioning technology using the pattern matching method. In this instance, a pattern matching database is required to be newly established anytime there is an additional establishment of a base station or environmental change. However, when the first SLDB 340 and the second SLDB 350 according to an embodiment of the present invention are applied, pattern matching database as illustrated in FIG. 13 may be simply and automatically established without an additional investment, even when a mobile communication network environment is changed.

As described above, in a system for determining a location of a mobile communication device 300 according to an embodiment of the present invention, the self-learning processing unit 330 batch processes GPS-based positioning results accumulated in the first SLDB 340, and thereby generates a sector direction value. Also, the self-learning processing unit 330 generates basic data for a pattern matching and optimized environment parameters, and updates the basic data and the optimized environment parameters in the second SLDB 350. In this instance, the optimized environment parameters are necessary for a wireless network-based positioning. The wireless network-based positioning system 320 receives the GPS-based positioning results accumulated in the second SLDB 350 via the self-learning processing unit 330, and performs a positioning by using the pattern matching method.

The system for determining a location of a mobile communication device 300 according to an embodiment of the present invention may be installed in the mobile communication device. A user who has the mobile communication device where the system for determining a location of a mobile communication device 300 is installed may be provided various services based on a location of the mobile communication device, while moving.

Also, the system for determining a location of a mobile communication device 300 may be installed in a particular positioning server which is connected with the mobile communication device. For example, the mobile communication device may transmit a signal received from base stations to the positioning server via a network. Accordingly, the positioning server may determine a location of the mobile communication device. Location information of the mobile communication device determined in the positioning server may be returned to the mobile communication device along with location-based service location. The positioning server may be located in a base station, a base station controller, or a base station exchanger. However, the positioning server may be located anywhere a signal may be received from the mobile communication device.

Considering a current radical improvement of a resource environment such as a processor, a memory, and a radio frequency (RF) module of the mobile communication device, the system for determining a location of a mobile communication device 300 according to an embodiment of the present invention is installed and operated in the mobile communication device. Accordingly, the mobile communication device may determine a location of the mobile communication device by itself without any help of a positioning server via a network. In this instance, base station identification information which is received from each base station is used for the determining. Specifically, the system for determining a location of a mobile communication device 300 is not established in a separate platform in a mobile communication network, and thereby may reduce a system load. The system load may occur due to a message which is transceived between the mobile communication device and the positioning server, when determining the location of the mobile communication device. Also, the system for determining a location of a mobile communication device 300 may reduce a cost to establish the separate platform, and thus a location based system (LBS) may be introduced quicker.

A base station identification signal in an embodiment described above may correspond to a general pilot signal. However, when the base station identification signals are signal received from each base station that may be distinguished and a power of each of the signals may be measured, another signal in another form may be used as the base station identification signal.

The above description has been described with an assumption of a downlink. In the downlink, a signal strength which is transmitted from base stations is measured by the mobile communication device or a predetermined positioning server, and thereby determining a current location. However, the above description may be applied to an uplink. In the uplink, a plurality of base stations receive base station identification signals which are transmitted from the mobile communication device, and the base station identification signals which are received in each of the base stations are collected in the predetermined positioning server via a network, and thus the positioning server may determine a location of the mobile communication device according to the system for determining the location of the mobile communication device 300. Location information of the mobile communication device determined in the positioning server may be returned to the mobile communication device along with location-based service location.

Also, the system for determining a location of a mobile communication device 300 according to an embodiment of the present invention may be applied to various kinds of wireless communication services such as a mobile communication network, a portable Internet, for example, a wireless broadband (Wibro), and the like.

The above-described embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

As described above, according to the present invention, a method and system for determining a location of a mobile communication device optimize an environment parameter set which is necessary for a wireless network-based positioning technology, according to a self-learning processing algorithm which uses an accumulated GPS-based positioning result. Accordingly, the method of and system for determining a location of a mobile communication device may overcome an excessive positioning error or a positioning failure without a huge cost. Also, the method of and system for determining a location of a mobile communication device is applicable to various types of networks such as a synchronous or asynchronous network. Also, the method of and system for determining a location of a mobile communication device may quickly cope with a wireless network base station information change and an environment change through a self-checking function, and thereby continuously supporting a maintaining of a quality positioning service.

1. A system for determining a location of a mobile communication device using a satellite signal, the system comprising: a first self-learning database storing a GPS-based positioning result, wireless network information for a base station identification, and a wireless network-based positioning result; a self-learning processing unit performing self-learning and generating a self-learning processing result associated with the network-based positioning by using the GPS-based positioning result, the wireless network information for the base station identification, and the wireless network-based positioning result; a second self-learning database accumulating the self-learning processing result corresponding to base station information; and a wireless network-based positioning unit generating the wireless network-based positioning result via the network-based positioning using the self-learning processing result, and updating the generated wireless network-based positioning result in the first self-learning database, wherein the self-learning processing unit performs the self-learning by reapplying the wireless network-based positioning according to a predetermined standard and updating the self-learning processing result.

2. The system of claim 1, further comprising: a GPS-based positioning unit performing the GPS-based positioning by using the wireless network information, and generating the GPS-based positioning result.

3. The system of claim 2, wherein the wireless network-based positioning unit stores the GPS-based positioning result, the wireless network information, and the wireless network-based positioning result in the first self-learning database in real time, when the GPS-based positioning unit performs a positioning.

4. The system of claim 2, wherein the wireless network-based positioning unit stores the wireless network-based positioning result, the GPS-based positioning result, and the wireless network information, in the first self-learning database, and the GPS-based positioning result, and the wireless network information being stored as a log file by the GPS-based positioning unit.

5. The system of claim 1, wherein the self-learning processing result comprises an average distribution direction or an average distribution angle from a base station which has at least one GPS-based positioning result with respect to a currently received base station identification signal.

6. The system of claim 1, wherein the self-learning processing result comprises pattern matching data, which corresponds to base station signal information, to determine the current location by comparing with a measured base station signal, and the wireless network-based positioning unit generates corresponding location information, which matches the base station identification signal currently received in the pattern matching data, as a corresponding wireless network-based positioning result.

7. The system of claim 1, wherein the self-learning processing unit locates the first self-learning database according to any one of a base station identifier and a sector identifier from the base station information corresponding to a currently received base station identification signal, extracts at least one GPS-based positioning result, and determines a sector direction value from the extracted at least one GPS-based positioning result, the sector direction value indicating an average distribution direction from a base station corresponding to at least one GPS-based positioning result which is determined based on a strength of a received signal of the wireless network information and a positioning accuracy.

8. The system of claim 7, wherein the self-learning processing unit extracts at least one wireless network-based positioning result having a difference between the GPS-based positioning result and the wireless network-based positioning result greater than a predetermined value, from the first self-learning database, reapplies the network-based positioning with respect to the extracted at least one wireless network-based positioning result by using parameter sets including the sector direction value, bases the wireless network-based positioning result and a corresponding
parameter set corresponding on the at least one wireless network-based positioning result having the least value, in the self-learning processing result among calculated wireless network-based positioning results, and thereby updates the wireless network-based positioning result and the corresponding parameter set in the second self-learning database.

9. The system of claim 8, wherein the self-learning processing unit displays a diagnose flag with respect to a region corresponding to the wireless network-based positioning result, when the difference between the GPS-based positioning result and all wireless network-based positioning results after reapplying the wireless network-based positioning result with respect to the parameter sets is greater than the predetermined value.

10. A method of determining a location of a mobile communication device using a satellite signal, the method comprising: storing a GPS-based positioning result, wireless network information for a base station identification, and a wireless network-based positioning result; performing self-learning and generating a self-learning processing result associated with the network-based positioning by using the GPS-based positioning result, the wireless network information for the base station identification, and the wireless network-based positioning result; accumulating the self-learning processing result corresponding to base station information; and generating the wireless network-based positioning result via the wireless network-based positioning using the self-learning processing result, and updating the generated wireless network-based positioning result in the first self-learning database, wherein the self-learning reapplies the wireless network-based positioning according to a predetermined standard and updates the self-learning processing result.

11. The method of claim 10, wherein the self-learning processing result comprises an average distribution direction or an average distribution angle from a base station which has at least one GPS-based positioning result with respect to a currently
received base station identification signal.

12. The method of claim 10, wherein the generating of the self-learning processing result comprises: locating the first self-learning database according to any one of a base station identifier and a sector identifier from the base station information corresponding to a currently received base station identification signal, and extracting at least one GPS-based positioning result; determining a sector direction value from the extracted at least one GPS-based positioning result, the sector direction value indicating an average distribution direction from a base station corresponding to at least one GPS-based positioning result which is determined based on a strength of a received signal of the wireless network information and a positioning accuracy.

13. The method of claim 12, wherein the generating of the self-learning processing result further comprises: extracting at least one wireless network-based positioning result having a difference between the GPS-based positioning result and the wireless network-based positioning result greater than a predetermined value, from the first self-learning database; reapplying the network-based positioning with respect to the extracted at least one wireless network-based positioning result by using parameter sets including the sector direction value; basing the wireless network-based positioning result and a corresponding parameter set corresponding on the at least one wireless network-based positioning result having the least value, in the self-learning processing result among calculated wireless network-based positioning results, and thereby updating the wireless network-based positioning result and the corresponding parameter set in the second self-learning database.

14. A computer-readable recording medium storing a program for implementing the method according to claim 10.
